(19) United States
(12) Patent Application Publication
(10) Pub. No.: US 2026/0149728 A1
(43) Pub. Date: May 28, 2026

(54) MULTI-TERRAIN AND CROSS-CLOUD DEFENSIVE CYBER SOLUTION

(71) Applicants: Marcus A. Cheney, Tampa, FL (US); Ralph J. Debardi, Tampa, FL (US); Brian C. Dutcher, Vail, AZ (US); Ty Henrichsmeyer, Vail, AZ (US); William T. Long, JR., Mount Joy, PA (US)

(72) Inventors: Marcus A. Cheney, Tampa, FL (US); Ralph J. Debardi, Tampa, FL (US); Brian C. Dutcher, Vail, AZ (US); Ty Henrichsmeyer, Vail, AZ (US); William T. Long, JR., Mount Joy, PA (US)

(21) Appl. No.: 18/958,016

(22) Filed: Nov. 25, 2024

(51) Int. Cl. H04L 9/40

(52) U.S. Cl. CPC H04L 63/1433; H04L 63/1416

(57) ABSTRACT

A method may include configuring a cloud platform at an initial position within a network; connecting the cloud platform to at least one terrain using data connectors; normalizing data entering a data pipeline; providing normalized data to an analyst node for analysis; identifying threats occurring within the ingested data of the at least one terrain via the analyst node; determining that the identified threats demonstrate malicious cyber-activity (MCA); and providing information on the determined MCA to at least one dedicated analyst node connected to the cloud platform within the network.

### TECHNICAL FIELD

The embodiments generally relate to the technical field of cloud-native platform cyber security.

### BACKGROUND

Conventional systems for cyber security in cloud-native platforms may include Security Information and Event Management (SIEM) and Security Orchestration, Automation, and Response (SOAR) solutions (collectively “SIEM-SOAR”) designed to help organizations detect, prevent, investigate, and respond to security threats in real-time.

SIEM-SOARs may include data connectors configured to ingest data from various sources, such as software programs, on-premises infrastructure, third-party services, and other cloud providers, and consolidate security logs and event data from firewalls, network devices, endpoints, and cloud services for centralized monitoring. SIEM-SOARs may be configured to identify patterns and anomalies within data that indicate a potential cyber security threat may be present. SIEM-SOARs may include features such as incident management, investigative tools, threat hunting tools, threat visualization via interactive dashboards, alert management, audit, and compliance tools, and log retention, among other features and tools.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system, method, and software product may include the steps of receiving a first set of information relating to a child-free individual; generating a digital document based on the first set of information; storing the digital document in a database; periodically communicating a notification to a device of the child-free individual; receiving a second set of information in response to the notification; modifying the digital document based on the second set of information; and updating the database with an updated digital document.

The disclosed system, method, and software product may perform the steps of configuring a cloud platform at an initial position within a network; connecting the cloud platform to at least one terrain using data connectors; normalizing ingested data from the at least one terrain; identifying threats occurring within the ingested data of the at least one terrain; determining that the identified threats demonstrate malicious cyber-activity (MCA); and providing information on the determined MCA to at least one dedicated analyst node connected to the cloud platform within the network.

In some aspects, the present invention includes at least one computing device in operable communication with a network and an application server in operable communication with the user network to host an application program, including an ingestion module, a node module, an analytics module, and a normalization module, in addition to other modules, configured to cooperatively provide multi-terrain (multiple computing environments) and cross-cloud defensive cyber capabilities.

In one aspect, an ingestion module is configured to receive data from at least one terrain (a monitored environment) and identify threats occurring within the ingested data of at least one terrain, which may include identifying threats that demonstrate malicious cyber-activity (MCA).

In one aspect, a node module is configured to determine the type of terrain on which an MCA is located and receive tactics, techniques, and procedures to respond to the MCA.

In one aspect, an analytics module is configured to provide information on the determined MCA to at least one dedicated analyst node connected to the cloud platform within the network. In embodiments, the analytics module is configured to provide custom analytics via an analyst node to the cloud platform on an identified MCA

In one aspect, a normalization module is configured to normalize data ingested by the ingestion module, regardless of the data source.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a block diagram of a multi-terrain and cross-cloud defensive cyber solution; and

FIG. 4 illustrates a flowchart of a method of implementing a multi-terrain and cross-cloud defensive cyber solution, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system may be a cloud-native integrated solution designed to provide multi-terrain and cross-cloud defensive cyber capabilities configured for detecting, analyzing, and responding to MCA across diverse environments. MCA may include, for example, malware infections, phishing, social engineering attacks, denial of service attacks, data exfiltration, advanced persistent threats, unauthorized IT assets or software deployments in an enterprise, on-premises or in the cloud, or insider threats. In embodiments, the system is built on a fungible architecture of software-as-a-service (SaaS) components, including combining multiple functionalities into a single, comprehensive solution to streamline cyber security operations by providing a centralized platform for hunting, detection, and analysis while also facilitating collaboration and information sharing among team members. The disclosed system includes a data ingest pipeline for normalizing data from various sources, enabling unified visibility across different cloud service providers (CSPs) and on-premises environments. In embodiments, the system provides cross-cloud visibility via standardized user interface dashboards, a single query language for searching diverse data sources, Infrastructure as Code (IaC) rapid automated deployment into cloud environments, modular, tailorable integration into existing systems, on-demand data sharing capabilities, normalized data ingestion regardless of data source, on-demand analyst interface environment including tear down and data destruction capabilities, and comprehensive support for multiple computing environment locations and teams. In this way, the system provides cross-cloud visibility, advanced data normalization, and collaborative features within a single platform.

Implementations of the invention involve the technical field of platform cyber security including configuring a cloud platform at an initial position within a network; connecting the cloud platform to at least one terrain using data connectors; normalizing ingested data from the at least one terrain; identifying threats occurring within the ingested data of the at least one terrain; determining that the identified threats demonstrate MCA; and providing information on the determined MCA to at least one dedicated analyst node connected to the cloud platform within the network and are therefore necessarily rooted in computer technology. The present invention amounts to more than merely implementing the generic computer as a tool to gather, analyze, and output data because the steps of the present method, system, or product improve the functioning of the computing environment on which they are executed by reducing the computing resources required to monitor, identify, and address MCA. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous communication of such data. That is, the steps of the present method, system, or product are impossible to accomplish on pen and paper, cannot be accomplished as a method of organizing human activity, and amount to significantly more than merely gathering, analyzing, and outputting data.

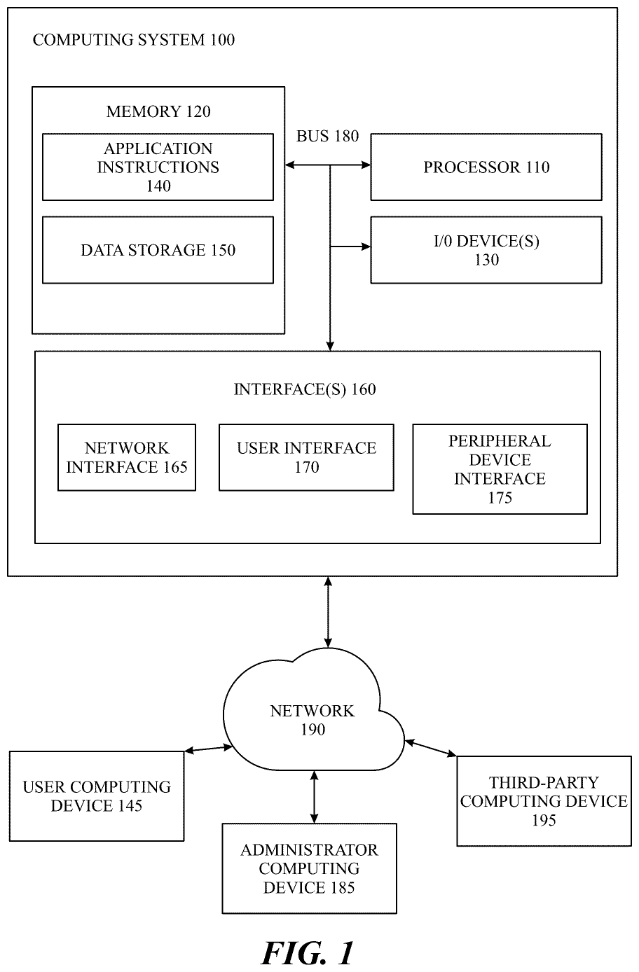

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes at least one processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes at least one input/output (I/O) devices 130, such as video device(s) (e.g., a camera), audio device(s), and display(s) are in operable communication with the computer system 100. In some embodiments, similar I/O devices 130 may be separate from the computer system 100 and may interact with at least one nodes of the computer system 100 through a wired or wireless connection, such as over a network interface.

Processors 110 suitable for the execution of computer readable program instructions include both general and special purpose microprocessors and any at least one processors of any digital computing device. For example, each processor 110 may be a single processing unit or a number of processing units and may include single or multiple computing units or multiple processing cores. The processor(s) 110 can be implemented as at least one microprocessors, microcomputers, microcontrollers, digital signal processors, central processing units, state machines, logic circuitries, and/or any devices that manipulate signals based on operational instructions. For example, the processor(s) 110 may be at least one hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to at least one of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, at least one mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of at least one programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes at least one interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

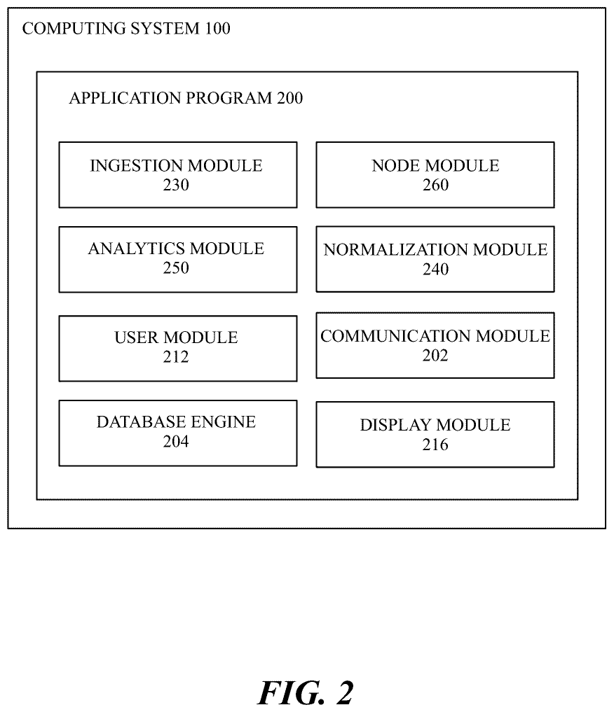

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in at least one databases. In particular, FIG. 2 is a block diagram showing the modules and engines needed to perform specific tasks within the application program 200.

Referring to FIG. 2, the computing system 100 operating the application program 200 comprises at least one module having the necessary routines and data structures for performing specific tasks and at least one engine configured to determine how the platform manages and manipulates data. In some embodiments, the application program 200 includes an ingestion module 230, a node module 260, an analytics module 250, a normalization module 240, a user module 212, a communication module 202, a database engine 204, and a display module 216.

In some embodiments, the ingestion module 230 is configured to receive network data passed to it by collectors or relays in the environment. The collected data is then normalized via the normalization module 240, which is then processed by the analytics module 230 by aggregating, analyzing, and correlating event logs and data from various sources, including real-time monitoring with historical analysis to detect, alert, and respond to security threats. The analytics module 250 may correlate events (network, endpoint, host, identity, security, etc.) from different terrains to detect complex patterns, including time-based or multi-layered correlation. In this way, the ingestion module may be configured to receive data from at least one terrain. In response to determining the context of MCA, node module 250 (analytics) is configured to retrieve or receive threat intelligence to respond to the MCA from subscribed providers and the collaboration node 304. In embodiments, the node module 260 includes a collaboration and command & control node for collaboration and information sharing across all elements, terrains, and/or users or teams. This may include a code repository stored by the database engine 204 to share custom analytics, a document repository for tactics, techniques, and procedure sharing and solution documentation, and a chat service for real-time collaboration.

In some embodiments, the analytics module 250 is configured to identify threats occurring within the ingested data of at least one terrain, including identifying threats that demonstrate MCA and provide information on the determined MCA to at least one dedicated analyst node connected to the cloud platform within the network. In some embodiments, the analytics module 250 is configured to identify the context of MCA including the systems and protocols involved. For example, analytics module 250 may identify whether MCA is originating from within an internal network (local IP addresses, devices) or from the external network (public IP addresses, internet-based servers) by performing network traffic analysis, analyzing firewall logs, or by intrusion detection systems and intrusion prevention systems. The analytics module 250 may be configured to identify the context of MCA via examining the protocols or applications involved in MCA, examining the source and destination of MCA, etc. In embodiments, the analytics module is configured to provide custom analytics via an analyst node to the cloud platform on an identified MCA. The analytics module 250 may be configured to process and analyze network data to identify patterns, potential threats, and malicious activity such as cyber-attacks, intrusions, or other unauthorized behavior. The analytics module 250 may analyze data from a plurality of sources, including network data from endpoints, servers, applications, and security systems across various terrains (computing environments). Collected data may include, for example, network packet data, host logs, and network flow data.. The analytics module 250 may be configured to identify or establish a baseline of normal network activity devoid of MCA but which includes typical traffic patterns, protocols, user behaviors, and device communications. The analytics module 250 may be configured to identify MCA by identifying deviations from normal network activity, such as unusual data transfer activity, abnormal logins, unexpected network connections, etcetera. In embodiments, the analytics module 250 may be configured to identify MCA based on known patterns or “signatures” of malicious activity. In embodiments, the analytics module 250 may be configured to perform behavior analysis of users on a network or device or endpoint behavior, including automated threat detection, predictive analysis, event correlation, or contextual awareness across multiple terrains.

In some embodiments, the normalization module 240 is configured to normalize data ingested by the ingestion module, regardless of the data source. Data normalization may include converting data formats to a common representation, standardizing units of measure, unifying categorical values, aligning naming conventions, managing missing or null data values, reconciling inconsistent data identifiers, merging multiple identical data points, normalizing date or time stamps, etc. Normalization may be, for example, rule-based including standardizing or transforming data according to a set of predefined rules defining how data should be adjusted, transformed, or cleaned to align with the desired format or standard. In some embodiments, the normalization module 240 is configured to normalize ingested data into a common schema such as via a filter to pair one schema to another. For example, ingested data having a first schema is mapped to a universal schema. In this way, the normalization module 240 ensure consistency and reduces errors regardless of the data source.

In some embodiments, the communication module 202 is configured for receiving, processing, and transmitting a user command and/or at least one data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow at least one users of the system, including a third-party, to communicate with one another. In some embodiments, the communications module 202 is configured to maintain at least one communication session with at least one server, the administrative computing device 185 of FIG. 1, and/or at least one third-party computing device(s) 195 of FIG. 1. In some embodiments, the communication module 202 may allow users and administrators to communicate with one another.

In some embodiments, a database engine 204 is configured to facilitate the storage, management, and retrieval of data to and from at least one storage medium, such as the at least one internal database described herein. In embodiments, the database engine 204 facilitates to management of a code repository configured to share custom analytics, a document repository for tactics, techniques, and procedure sharing and solution documentation, and a chat service for real-time collaboration. In some embodiments, the database engine 204 is coupled to an external storage system. In some embodiments, the database engine 204 is configured to apply changes to at least one database. In some embodiments, the database engine 204 comprises a search engine component for searching through thousands of data sources stored in different locations. In some embodiments, the database engine 204 comprises a natural language artificial intelligence, bot assisted search component for searching through thousands of data sources from prior missions and or analyst engagements. In some embodiments, the database engine 204 is configured to publish rules of engagement to a command and control node in via the node module 260.

The user module 212 may store user preferences including the user account information, unit or team assignment, historical usage data, user personal information, and the like. The user module 212 may facilitate the creation of user profiles for users, administrators, and others.

In some embodiments, the display module 216 is configured to display at least one graphic user interface, including, e.g., at least one user interface. In some embodiments, the display module 216 is configured to temporarily generate and display various pieces of information in response to at least one command or operation. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user's device, which can be viewed and acknowledged by the user.

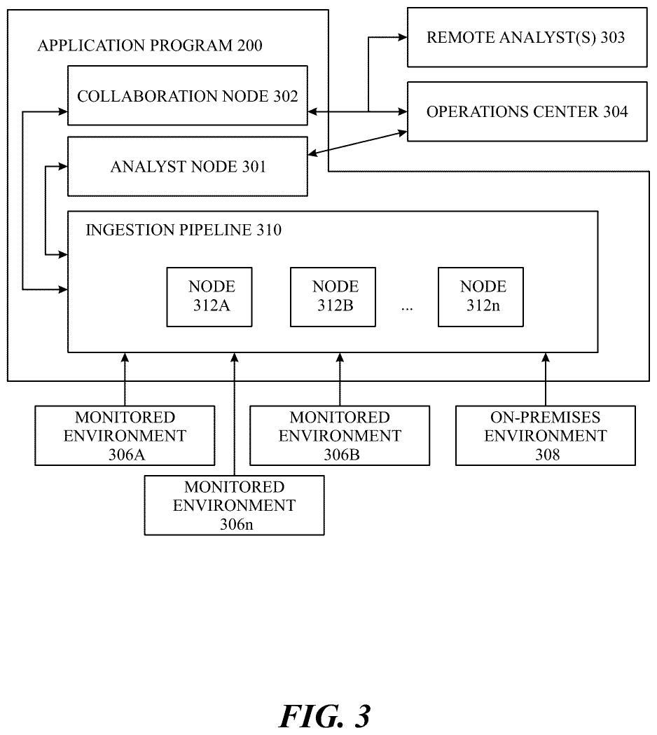

FIG. 3 illustrates a block diagram of a multi-terrain and cross-cloud defensive cyber solution method for multi-terrain and cross-cloud defensive cyber capabilities. An application program 200 corresponding to the applications instruction 140 of FIG. 1 and the application program 200 of FIG. 2 may include a collaboration node 302 corresponding to the node module 260 of FIG. 2 and an ingestions pipeline 310 corresponding to the ingestion pipeline of FIG. 2. The collaboration node 302 may be in operable communication with an operations center 304 and remote analyst(s) 303 performing SIEM-SOAR functions. The collaboration node 302 may be used by remote analyst(s) 303 to monitor or receive information from the ingestion pipeline 310 containing a plurality of nodes 312A, 312B, and 312n (corresponding to any number of additional nodes). In this way, the collaboration node 302 allows a remote analyst to connect to the system and access the full collaboration node and an assigned analyst node 301, including any assets deployed into the mission partner environment, on-premises, or in the cloud. Nodes 312A, 312B, and 312n may be in operable communication with any of the monitored environments 306A, 306B, and 306n (corresponding to any number of additional monitored environments) and on-premises environment 308. Monitored environments 306A, 306B, and 306n and on-premises environment 308 may be computing terrains as previously described. Activity on any of the monitored environments 306A, 306B, and 306n and on-premises environment 308 may be received by the ingestion pipeline 310 through nodes 312A, 312B, and 312n via the ingestion module 230 and node module 260 of FIG. 2 via a data connector configured to function as a communication pathway for connecting a solution and monitored environment. Ingested activity data may be normalized via the normalization module 240 of FIG. 2 within nodes 312A, 312B, and 312n and may be paired to a source, such as monitored environments 306A, 306B, and 306n, including a corresponding data connector. The application program 200 may perform analysis of the ingested activity data via the analytics module 250 of FIG. 2. Analytical data may be accessible by users (remote analyst(s) 303) via the collaboration node 302. In this way, the application program 200 is configured to normalize ingested data from at least one terrain (monitored environments 306A, 306B, and 306n and on-premises environment 308); identify threats occurring within the ingested data of the at least one terrain (via the ingestion pipeline 310); determine that the identified threats demonstrate malicious cyber-activity (MCA) (via the ingestion pipeline 310); and provide information on the determined MCA to at least one dedicated analyst node 301 connected to the cloud platform within the network.

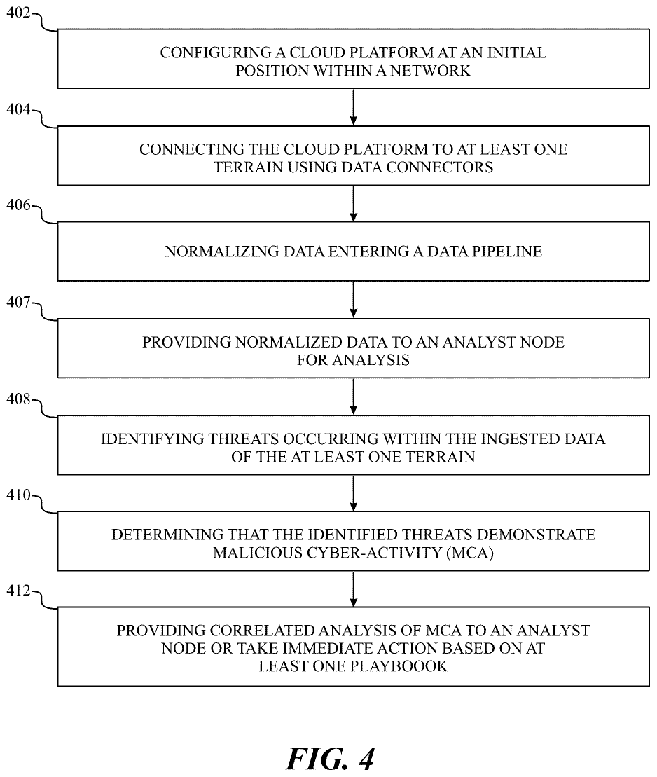

FIG. 4 illustrates a flowchart of a method of implementing a multi-terrain and cross-cloud defensive cyber solution, according to some embodiments. In step 402, the system may configure a cloud platform at an initial position within a network via the application program 200 of FIG. 2. In step 404, the system may connect the cloud platform to at least one terrain using data connectors via the application program 200 of FIG. 2. In step 406, the system may normalize ingested data from the at least one terrain via the normalization module 240 of FIG. 2. In step 407, the system may provide the normalized data to an analyst node via the normalization module 240 of FIG. 2. In step 408, the system may identify threats occurring within the ingested data of the at least one terrain via the ingestion module 230 of FIG. 2. In step 410, the system may determine that the identified threats demonstrate malicious cyber-activity (MCA) via the ingestion module 230 of FIG. 2. In step 412, the system may provide correlated analysis of MCA to an analyst node, depicted as analyst node 301 in FIG. 3, connected to the cloud platform within the network via the analytics module 250 of FIG. 2, or to provide instructions to take immediate action based on at least one TTP playbook.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises at least one executable instruction for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with at least one specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. At least one components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having at least one data packet (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine or microcomputing, i.e. a service running in a container, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, Mac OS, and the cloud usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a physical or virtual computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method comprising:
configuring, by a computing device, a cloud platform at an initial position within a network;
connecting, by the computing device, the cloud platform to at least one terrain using data connectors;
normalizing, by the computing device, data entering a data pipeline;
providing, via the computing device, normalized data to an analyst node for analysis;
identifying, by the computing device, threats occurring within the ingested data of the at least one terrain via the analyst node;
determining, by the computing device, that at least one identified threats demonstrate malicious cyber-activity (MCA); and
providing, by the computing device, information on a determined MCA to at least one dedicated analyst node connected to the cloud platform within the network.

2. The computer-implemented method of claim 1, further comprising providing custom analytics by the at least one dedicated analyst node to the cloud platform on the identified MCA.

3. The computer-implemented method of claim 1, further comprising publishing rules of engagement with at least one mission partners to a command and control node.

4. The computer-implemented method of claim 1, further comprising determining a type of terrain of at least one terrain among the at least one terrain in which the MCA is located.

5. The computer-implemented method of claim 1, further comprising configuring a document repository within a command and control node to provide tactics, techniques, and procedures to respond to the MCA.

6. The computer-implemented method of claim 1, wherein the information on the determined MCA comprises tactics, techniques, and procedures to respond to the identified MCA.

7. The computer-implemented method of claim 1, wherein the at least one dedicated analyst node is a plurality of dedicated analyst nodes.

8. A system comprising:
at least one computing device in operable communication with a network;
an application server in operable communication with the at least one computing device over the network, the application server configured to host an application program configured to:
configure a cloud platform at an initial position within a network;
connect the cloud platform to at least one terrain using data connectors;
normalize data entering a data pipeline;
provide normalized data to an analyst node for analysis;
identify threats occurring within the ingested data of the at least one terrain via the analyst node;
determine that at least one identified threats demonstrate malicious cyber-activity (MCA);
provide information on a determined MCA to at least one dedicated analyst node connected to the cloud platform within the network; and
receive threat intelligence at the at least one dedicated analyst node.

9. The system of claim 8, wherein the at least one computing device is further configured to configure a code repository to store and transmit custom analytics on the MCA.

10. The system of claim 8, wherein at least one computing device is further configured to configure a virtual gateway connection and a data connector based on a specific type of the at least one terrain.

11. The system of claim 8, wherein the at least one computing device is further configured to identify at least one type of threat associated with the MCA.

12. The system of claim 8, wherein the at least one computing device is further configured to perform configuring a document repository within a command and control node to provide the tactics and procedures to respond to the MCA.

13. The system of claim 8, wherein the at least one computing device is further configured to publish rules of engagement with at least one mission partner to a command and control node.

14. A software product comprising:
at least one computing device in operable communication with a network;
an application server in operable communication with the at least one computing device over the network, the application server configured to host an application program configured to:
configure a cloud platform at an initial position within a network;
connect the cloud platform to at least one terrain using data connectors;
normalize data entering a data pipeline;
provide normalized data to an analyst node for analysis;
identify threats occurring within the ingested data of the at least one terrain via the analyst node;
determine that at least one identified threat demonstrate malicious cyber-activity (MCA); and
provide information on a determined MCA to at least one dedicated analyst node connected to the cloud platform within the network.

15. The software product of claim 14, wherein the at least one computing device is further configured to provide custom analytics by at least one dedicated analyst node to the cloud platform on the identified MCA.

16. The software product of claim 14, wherein the at least one computing device is further configured to publish rules of engagement with at least one mission partner to a command and control node.

17. The software product of claim 14, wherein the at least one computing device is further configured to communicate to the analyst node a number of the at least one identified threats that constitute the MCA.

18. The software product of claim 17, wherein the information on the identified MCA comprises tactics, techniques, and procedures to respond to the identified MCA.

19. The software product of claim 14, wherein the at least one computing device is further configured to communicate with a command and control node, in at least one interval, additional information on the terrains that contain the MCA.

20. The software product of claim 14, wherein the at least one computing device is further configured to receive custom analytics from a command and control node on the MCA identified within the terrains.
